(19) United States
(12) Patent Application Publication
(10) Pub. No.: US 2018/0325188 A1
(43) Pub. Date: Nov. 15, 2018

(54) GARMENT WITH ELASTIC WAISTBAND

(71) Applicant: THE MARENA GROUP, LLC, Lawrenceville, GA (US)

(72) Inventors: Linda Marie BURHANCE, Newtown, CT (US); Jeffrey Dan STEPHENS, Atlanta, GA (US)

(21) Appl. No.: 15/976,337

(22) Filed: May 10, 2018

Related U.S. Application Data
(60) Provisional application No. 62/504,764, filed on May 11, 2017.

(51) Int. Cl. A41D 1/08; A41D 27/00; B32B 5/26

(52) U.S. Cl. CPC A41D 1/08; A41D 27/00; B32B 2437/00; A41D 2500/10; B32B 2307/51; B32B 5/26

(57) ABSTRACT

A garment with an elastic waistband having a first leg portion, a second leg portion, and a waistband portion. The waistband portion includes a front panel portion having layers of at least one elastic material, a rear panel portion having layers of at least one elastic material, a first side panel portion having layers of at least one elastic material, and a second side panel portion having layers of at least one elastic material, each panel having a first edge and a second edge, and each panel having a top edge and a bottom edge. The number of layers in the first side panel portion and the second side panel portion is greater than the number of layers in the front panel portion and the rear panel portion. Also disclosed is an elastic band for use in a garment or other wearable article.

### CROSS-REFERENCE TO RELATED APPLICATION

This application claims benefit of co-pending U.S. provisional patent application No. 62/504,764, filed May 11, 2017, entitled GARMENT WITH ELASTIC WAISTBAND, and commonly assigned to the assignee of the present application, the disclosure of which is incorporated by reference in its entirety herein.

### FIELD

The present disclosure relates, in exemplary embodiments, to garments, particularly leggings and other pant-type garments. In exemplary embodiments, the present disclosure relates to leggings with an elastic waistband which prevents, or reduces the likelihood of, the waistband from rolling or sliding down the user's waist.

### BACKGROUND

Some legging, pants, shorts or other garments worn by people during exercise, such as running, bending or stretching, have a waistband that has a tendency to either roll or slide down the wearer's waist due to inadequate construction. Typically, elastic waistbands are constructed whereby the elasticity warp direction is different than the elasticity in the perpendicular weft direction, which can result in inadequate shape retention of the waistband and thus, rolling. It would be desirable to have a legging/pant-type garment with a waistband that prevents or reduces the tendency to roll, yet is comfortable and does not pinch or constrict at the waist.

### BRIEF DESCRIPTION OF THE DRAWINGS

The drawings disclose exemplary embodiments in which like reference characters designate the same or similar parts throughout the figures of which:

FIG. 1 is a front elevational view of one exemplary embodiment of the present disclosure.

FIG. 2 is a rear elevational view of the exemplary embodiment of FIG. 1.

FIG. 3 is a left side elevational view of the exemplary embodiment of FIG. 1.

FIG. 4 is a right side elevational view of the exemplary embodiment of FIG. 1.

FIG. 5 is a detailed top plan cutaway view of the waistband portion of the exemplary embodiment of FIG. 1.

FIG. 6 is a top plan view of an exemplary embodiment of an elastic band.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of the invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

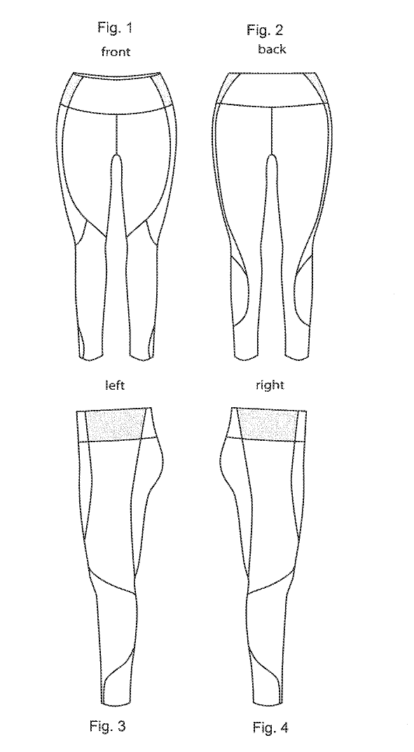

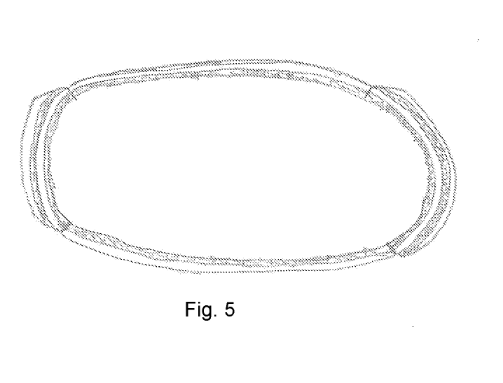

FIGS. 1-4 shows one exemplary embodiment of a leggings-type garment generally comprising a first leg portion, second leg portion, and a waistband portion. In one exemplary embodiment, the first and second leg portions are made of an elastic material, such as, but not limited to at least one compression fabric, such as, but not limited to, at least one warp knit compression fabric. Alternatively, the legging may be made of nylon spandex or other suitable elastic material.

In one exemplary embodiment, the waistband portion comprises front panel, rear panel, first side panel, and second side panel portions, each panel having a first edge and a second edge, and each panel having a top edge and a bottom edge.

In exemplary embodiments, the front panel may comprise at least two layers of an elastic material, such as, but not limited to, at least one compression fabric, such as, but not limited to, at least one warp knit compression fabric. In one exemplary embodiment, the front panel comprises at least four layers of at least one elastic material. In one exemplary embodiment, the elastic material is COMFORTWEAR® brand elastic material (available from The Marena Group, LLC, Lawrenceville, Ga.). In one exemplary embodiment, the elastic material can be nylon spandex. In one exemplary embodiment, the front panel layers can each be formed of a piece of material generally having the same shape, with each layer being disposed over each other in a layered fashion. In exemplary embodiments, each side, top and bottom edge (or a portion of each) of the first layer can be tack stitched (or connected by other methods known to those skilled in the art) to the corresponding edge of the other layer. In exemplary embodiments, the rear panel can be constructed in a manner similar to that of the front panel. In exemplary embodiments, the rear panel may be made of a different elastic material (or materials) from that of the front panel.

In one exemplary embodiment, the first side panel layers can each be formed of a piece of material generally having the same shape, with each layer being disposed over each other in a layered fashion. In exemplary embodiments, each side, top and bottom edge (or a portion of each) of the first layer can be tack stitched to the corresponding edge of the other layers. The second side panel can be constructed in a manner similar to that of the front panel.

In other exemplary embodiments fewer or greater than four layers can be utilized with each of the first and second side panels. In one exemplary embodiment, the number of layers for the first side panel may be different from the number of layers for the second side panel, such as for particular customized uses where a user may have a sensitivity to pressure on one side of his or her waist area. In exemplary embodiments, the front panel and/or back panel may each incorporate one layer made of a first material and a second layer made of a second material. In exemplary embodiments, the first panel and/or second side panel may have the layers all made of the same material, or may have one or more layers made of different materials. The term “different materials” is intended to include, but is not limited to, different polymer chemical makeup (e.g., more than one polymer or copolymer) or microstructure, as well as materials having the same polymer chemical makeup or microstructure but manufactured to have different properties, such as, but not limited to, elasticity, breathability, wicking, durability, or the like.

In exemplary embodiments, the panel fabric layers may be aligned with the warp direction of each layer, or may have one layer (or in the case of the first and second side panels, layers) having the warp direction being nonparallel with the warp direction of an adjacent layer.

In exemplary embodiments, the first and second side panels may exert a combined compressive pressure in a range of about 20-30 mmHg. In exemplary embodiments, the first and second side panels may exert a combined compressive pressure of about 40 mmHg. In exemplary embodiments, the first and second side panels may exert a combined compressive pressure in a range of about 20-30 mmHg. In exemplary embodiments, the front panel and rear panel may exert a combined compressive pressure in a range of about 40-53 mmHg.

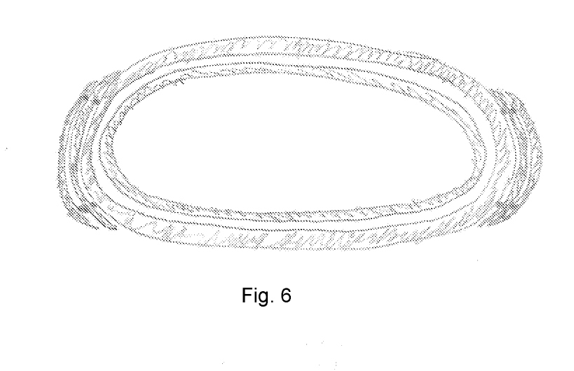

FIG. 6 shows an exemplary embodiment comprising an elastic band comprising a front panel portion comprising a plurality of layers of at least one elastic material, a rear panel portion comprising a plurality of layers of at least one elastic material, a first side panel portion comprising a plurality of layers of at least one elastic material, and a second side panel portion comprising a plurality of layers of at least one elastic material. Each panel has a first edge and a second edge. Each panel has a top edge and a bottom edge. The number of layers comprising each of the first side panel portion and the second side panel portion is greater than the number of layers comprising each of the front panel portion and the rear panel portion. In one exemplary embodiment, the first side panel portion and the second side panel portion each have four layers. In one exemplary embodiment, the front panel portion and the rear panel portion each have two layers. In one exemplary embodiment, the at least one elastic material comprises a compression fabric having elasticity in the warp direction being substantially the same (e.g., within 10-20%) as the elasticity in the weft direction.

FIG. 7 shows an exemplary embodiment of an elastic band comprising a first band made of at least one elastic material and a second band made of at least one elastic material. A first side portion comprises at least one layer of fabric made of at least one elastic material. A second side portion comprises at least one layer of fabric made of at least one elastic material. In exemplary embodiments, the first and second side portions each comprise a plurality of layers of fabric. In exemplary embodiments, the first and second side portions each comprise two layers of fabric. The fabric layers of the first side portion may be tack stitched (or otherwise connected to each other) together and/or to the first and/or second band to hold the fabric layers together. Similarly, the fabric layers of the second side portion may be tack stitched (or otherwise connected to each other) together and/or to the first and/or second band to hold the fabric layers together.

A feature of exemplary embodiments of the present invention is that the material used in construction of the waistband in exemplary embodiments, namely the COMFORTWEAR® fabric, has substantially the same elasticity in the warp direction as it has in the weft direction. In exemplary embodiments, the elasticity difference may be within 10-20%. This balancing of directional elasticity, along with the use of the various layers of material in construction, provides a waistband

A feature of the present invention is the greater pressure on the waistline of the first and second side panels (compared to the pressure exerted by the front and rear panels) which creates a structure that maintains the waistband in place and prevents, or reduces the likelihood of, the waistband rolling or sliding down on the user, particularly during activity, such as running, exercise or other activities.

It is to be understood that other types of garments or articles are also contemplated as being within the scope of the present disclosure, such as, but not limited to, pants, shorts, underwear, socks, knit-type hats and caps, arm sleeves, leg sleeves, dresses, skirts, skorts, compression garments, girdles, waist cinchers, abdominal binders, and the like. It is to be understood that the elastic band of the present disclosure can be incorporated in various types of garments or wearable articles, including, but not limited to, headbands, armband, wristbands, wraps, and the like.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

As used in the specification and the appended claims, the singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It should further be noted that any patents, applications and publications referred to herein are incorporated by reference in their entirety.

What is claimed is:

1. A garment with an elastic waistband, comprising:
a) a first leg portion;
b) a second leg portion; and,
c) a waistband portion comprising
i) a front panel portion comprising a plurality of layers of at least one elastic material,
ii) a rear panel portion comprising a plurality of layers of at least one elastic material,
iii) a first side panel portion comprising a plurality of layers of at least one elastic material, and
iv) a second side panel portion comprising a plurality of layers of at least one elastic material,
v) each panel having a first edge and a second edge, and each panel having a top edge and a bottom edge,
wherein the number of layers comprising each of the first side panel portion and the second side panel portion is greater than the number of layers comprising each of the front panel portion and the rear panel portion.

2. The garment of claim 1, wherein the first side panel portion and the second side panel portion each have four layers.

3. The garment of claim 1, wherein the front panel portion and the rear panel portion each have two layers.

4. The garment of claim 1, wherein the at least one elastic material comprises a compression fabric having elasticity in the warp direction being substantially the same as the elasticity in the weft direction.

5. The garment of claim 1, wherein the at least one elastic material comprises a compression fabric having elasticity in the warp direction being within 10-20% of the elasticity in the weft direction.

6. The garment of claim 1, wherein the waistband portion has reduced tendency to roll or slide down during activity.

7. An elastic band adapted for use in a garment or other wearable article, the elastic band comprising:
a) a front panel portion comprising a plurality of layers of at least one elastic material,
b) a rear panel portion comprising a plurality of layers of at least one elastic material,
c) a first side panel portion comprising a plurality of layers of at least one elastic material, and
d) a second side panel portion comprising a plurality of layers of at least one elastic material,
e) each panel having a first edge and a second edge, and each panel having a top edge and a bottom edge,
wherein the number of layers comprising each of the first side panel portion and the second side panel portion is greater than the number of layers comprising each of the front panel portion and the rear panel portion.
